(19) United States
(12) Patent Application Publication
(10) Pub. No.: US 2020/0152978 A1
(43) Pub. Date: May 14, 2020

(54) POSITIVE ACTIVE MATERIAL, METHOD OF MANUFACTURING THE SAME AND RECHARGEABLE LITHIUM BATTERY INCLUDING THE SAME

(71) Applicants: Samsung SDI Co., Ltd., Yongin-si (KR); Seoul National University R&DB Foundation, Seoul (KR)

(72) Inventors: Kwanghwan CHO, Yongin-si (KR); Kisuk KANG, Seoul (KR); Ilseok KIM, Yongin-si (KR); Won Mo SEONG, Seoul (KR)

(21) Appl. No.: 16/677,307

(22) Filed: Nov. 7, 2019

(30) Foreign Application Priority Data
Nov. 14, 2018 (KR) 10-2018-0140301

(51) Int. Cl. H01M 4/36; H01M 4/485; H01M 4/131; H01M 4/1391

(52) U.S. Cl. CPC H01M 4/366; H01M 4/485; H01M 2004/028; H01M 4/1391; H01M 4/131

(57) ABSTRACT

One or more example embodiments of the present disclosure provide a positive active material, a rechargeable lithium battery including the same, and a method of preparing the same. The positive active material includes a lithium-containing composite oxide; and a sulfur-containing inorganic lithium compound, wherein the sulfur-containing inorganic lithium compound forms a coating layer on a surface of the lithium-containing composite oxide. The coating layer may reduce an amount of residual lithium and gas present on the surface of the lithium-containing composite oxide, thereby improving the stability of the battery and improving the cycle-life characteristics.

### CROSS-REFERENCE TO RELATED APPLICATION

This application claims priority to and the benefit of Korean Patent Application No. 10-2018-0140301, filed in the Korean Intellectual Property Office on Nov. 14, 2018, the entire content of which is incorporated herein by reference.

### BACKGROUND

### 1. Field

One or more aspects of example embodiments of the present disclosure are related to a positive active material, a method of manufacturing the same, and a rechargeable lithium battery including the same.

### 2. Description of the Related Art

As small high-tech devices (such as a digital camera, a mobile device, a laptop, a computer, and/or the like are developed), the demand for rechargeable lithium batteries as an energy source is sharply increasing. In addition, safe high-capacity lithium ion batteries are being developed for increased use of electric vehicles (EV), including hybrid, plugin, electric vehicles (HEV, PHEV, EV, and/or the like). Accordingly, various suitable positive active materials are being developed in order to realize a rechargeable lithium battery satisfying the above uses. Lithium cobalt oxide (LiCoO₂) having (e.g., consisting of) a single component is frequently used as the positive active material in a rechargeable lithium battery, but high-capacity layered structure-type lithium composite oxides (e.g., Li(Ni—Co—Mn)0₂, Li(Ni—Co—Al)O₂, etc.) are increasingly being used. In addition, spinel-type lithium manganese oxide (LiMn₂O₄) and olivine-type lithium iron phosphate (LiFePO₄) materials, which have high safety, are attracting interest. Much research has focused on increasing the nickel content of the lithium composite metal oxide in order to increase the capacity of rechargeable lithium batteries.

However, as the nickel content of the lithium composite metal oxide is increased, the rate or probability of Ni²⁺ substituting a lithium site and thus easily forming an NiO impurity may also be increased. The formed NiO is highly reactive and may react with an electrolyte, and may also be locally cross-linked to form a three-dimensional structure that hinders diffusion of lithium ions. Accordingly, structural stability of the battery may be deteriorated, and battery capacity also may be decreased. In addition, because an excessive amount of a lithium source is used to prepare lithium composite metal oxides having a high nickel content, a large amount of unreacted lithium remains on the surface of the prepared lithium composite metal oxide. This residual lithium may react with water or CO₂ to generate a base such as LiOH, Li₂CO₃, and/or the like, and these bases may also react with the electrolyte to generate CO₂ gas. Accordingly, an internal pressure of the battery is increased, and as a resultant, cycle-life characteristics and safety battery may be deteriorated.

A method of improving the structural stability of a positive active material having a high nickel content and/or enhancing cycle-life characteristics of a corresponding lithium battery is desired.

### SUMMARY

One or more aspects of embodiments of the present disclosure are directed toward a positive active material having improved stability.

One or more aspects of embodiments of the present disclosure are directed toward a method of preparing the positive active material.

One or more aspects of embodiments of the present disclosure are directed toward a rechargeable lithium battery having improved cycle-life characteristics due to the positive active material.

One or more example embodiments of the present disclosure provide a positive active material for a rechargeable lithium battery including a lithium-containing composite oxide; and a sulfur-containing inorganic lithium compound, wherein the sulfur-containing inorganic lithium compound forms a coating layer on a surface of the lithium-containing composite oxide.

In some embodiments, an X-ray photoelectron spectroscopy (XPS) binding energy peak of the sulfur-containing inorganic lithium compound may be exhibited at about 168 eV to about 172 eV.

In some embodiments, the sulfur-containing inorganic lithium compound may include lithium sulfate.

In some embodiments, the lithium of the sulfur-containing inorganic lithium compound may be derived from the lithium-containing composite oxide.

In some embodiments, the coating layer may have a thickness of about 1 nm to about 100 nm.

In some embodiments, the sulfur-containing inorganic lithium compound may be included in an amount of about 1 wt % to about 20 wt % based on a total weight of the positive active material.

In some embodiments, the coating layer may be formed as a uniform film on a surface of the lithium-containing composite oxide.

In some embodiments, a nickel content of the lithium-containing composite oxide may be greater than or equal to about 55 at % based on a total amount of metals except lithium.

In some embodiments, the nickel content of the lithium-containing composite oxide may be greater than or equal to about 80 at % based on a total amount of metals except lithium.

In some embodiments, the lithium-containing composite oxide may include a lithium nickel composite oxide represented by Chemical Formula 1:

### Chemical Formula 1

Liₐ(NiₓM_{y}′M_{z}″)O₂.

In Chemical Formula 1, M′ is at least one element selected from Co, Mn, Ni, Al, Mg, and Ti, M″ is at least one element selected from Ca, Mg, Al, Ti, Sr, Fe, Co, Mn, Ni, Cu, Zn, Y, Zr, Nb, and B, 0.8<a ≤1.2, 0.6≤x≤1, 0≤y≤0.4, 0z≤0.4, and 0.6≤x+y+z≤1.2.

In some embodiments, the lithium-containing composite oxide may include a lithium nickel composite oxide represented by Chemical Formula 2:

### Chemical Formula 2

Liₐ(NiₓCo_{y}Mn_{z})O₂.

In Chemical Formula 2, 0.8<a≤1.2, 0.6≤x≤1, 0≤y≤0.4, 0≤z≤0.4, and 0≤x+y+z≤1.2.

In some embodiments, the positive active material may have a specific surface area (BET) of about 0.01 m²/g to about 10 m²/g.

One or more example embodiments of the present disclosure provide a method of preparing a positive active material for a rechargeable lithium battery including: injecting (mixing) a metal hydroxide precursor and a lithium source and firing the same at about 700° C. to about 800° C., wherein a sulfur-containing gas is injected (added) during the firing while decreasing a temperature.

In some embodiments, an injection temperature of the sulfur-containing gas may be about 400° C. to about 600° C.

In some embodiments, an injection time of the sulfur-containing gas may be about 10 seconds to about 300 seconds.

In some embodiments, the injection amount (e.g., rate) of sulfur-containing gas may be about 0.1 L/min to about 2 L/min.

In some embodiments, the sulfur-containing gas may include about 5 volume % to about 100 volume % of sulfur dioxide (SO₂) gas (gaseous state sulfur dioxide).

In some embodiments, the lithium source may be further injected during injecting the sulfur-containing gas. For example, an addition lithium source may be further injected concurrently or simultaneously with the sulfur-containing gas.

One or more example embodiments of the present disclosure provide a rechargeable lithium battery including a positive electrode including the positive active material; a negative electrode; a separator disposed between the positive electrode and the negative electrode; and an electrolyte solution between the positive electrode and the negative electrode.

According to embodiments of the present disclosure, residual lithium and gas generated on the surface of the positive active material may be suppressed and a rechargeable lithium battery with improved cycle-life characteristics may be obtained.

### BRIEF DESCRIPTION OF THE DRAWINGS

FIG. 1 is a schematic cross-sectional view of a positive active material according to an embodiment of the present disclosure.

FIG. 2 is a schematic perspective view of a representative structure of a rechargeable lithium battery.

FIG. 3 is a graph showing results of XPS (X-ray photoelectron spectroscopy) depth profiling of the positive active material prepared in Example 1.

FIG. 4A is a digital image showing the results of energy dispersive spectroscopy (EDS) mapping analysis of sulfur (S) present on the surface of the positive active material prepared in Example 1.

FIG. 4B is a digital image showing the results of EDS mapping analysis of sulfur (S) present on the surface of the positive active material prepared in Comparative Example 1.

FIG. 5 is a graph showing an X-ray diffraction (XRD) spectrum of the positive active materials prepared in Examples 1, 4, and 6 and Comparative Example 1.

### DETAILED DESCRIPTION

Hereinafter, embodiments of the present disclosure are described in more detail. Aspects of example embodiments are illustrated in the accompanying drawings, wherein like reference numerals refer to like elements throughout and duplicative descriptions thereof may not be provided. However, the embodiments are examples, the present disclosure is not limited thereto, and the present disclosure is defined by the scope of claims.

In the drawings, the thicknesses of layers, films, panels, regions, etc., may be exaggerated for clarity. It will be understood that when an element such as a layer, film, region, or substrate is referred to as being “on” another element, it can be directly on the other element or intervening element(s) may also be present. In contrast, when an element is referred to as being “directly on” another element, no intervening elements are present.

Expressions such as “at least one of”, “one of”, “selected from”, “at least one selected from”, and “one selected from”, when preceding a list of elements, modify the entire list of elements and do not modify the individual elements of the list. Further, the use of “may” when describing embodiments of the present disclosure refers to “one or more embodiments of the present disclosure.

One or more example embodiments of the present disclosure provide a positive active material for a rechargeable lithium battery including a lithium-containing composite oxide; and a sulfur-containing inorganic lithium compound, wherein the sulfur-containing inorganic lithium compound forms a coating layer on a surface of the lithium-containing composite oxide.

When a high nickel-content metal oxide prepared from a metal hydroxide precursor is washed with water, residual lithium on the surface of the positive active material may be removed, but since a contact area of the positive active material with an electrolyte is increased, side reactions and the like may be caused, and there may be a problem of deteriorating cycle-life characteristics due to gas generation or degraded battery stability cause by an increase in DC internal resistance.

However, the positive active material according to an embodiment of the present disclosure is prepared by substituting the sulfur-containing inorganic lithium compound for the residual lithium on the surface, thereby forming a coating layer on the surface of the lithium-containing composite oxide that may suppress residual lithium and gas generation to improve the cycle-life characteristics of the battery.

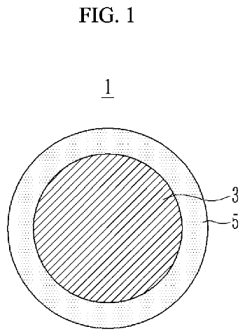

Hereinafter, a positive active material according to an embodiment of the present disclosure is described referring to FIG. 1.

FIG. 1 is a schematic cross-sectional view of a positive active material according to an embodiment of the present disclosure.

Referring to FIG. 1, a positive active material 1 according to an embodiment of the present disclosure includes a lithium-containing composite oxide 3; and a coating layer 5 disposed (positioned) on its surface.

The coating layer 5 may be a uniform thickness film (e.g., may be a film having a substantially uniform thickness) including a sulfur-containing inorganic lithium compound formed on the surface of the lithium-containing composite oxide 3. The coating layer 5 may have a thickness of greater than or equal to about 1 nm, greater than or equal to about 10 nm, or greater than or equal to about 15 nm, and less than or equal to about 100 nm, less than or equal to about 90 nm, less than or equal to about 80 nm, less than or equal to about 70 nm, less than or equal to about 60 nm, less than or equal to about 50 nm, less than or equal to about 40 nm, less than or equal to about 30 nm, or less than or equal to about 20 nm, for example, about 1 nm to about 20 nm, or about 1 nm to about 10 nm. When the thickness of the coating layer 5 is in the above-described ranges, the capacity and cycle-life characteristics of a rechargeable battery may be further improved. For example, when the thickness of the coating layer 5 is in the above-described ranges, the specific surface area (BET) of the positive active material may be controlled to a desired or suitable range, and the capacity characteristic may be improved greatly.

The coating layer 5 including the sulfur-containing inorganic lithium compound generally differs in a shape from related art coating layers formed of a sulfur-containing organic compound that coats a surface of the positive active material. For example, the sulfur-containing organic compound is prepared as gas and not uniformly dispersed on the surface of the lithium-containing composite oxide and accordingly, not formed into a substantially uniform layer on the surface of the lithium-containing composite oxide as in the present disclosure. In addition, the coating layer formed of the sulfur-containing organic compound has a problem of not maintaining a shape stability (e.g., not having a stable shape), since a part (portion) thereof including carbon is carbonized when a temperature of the active material is increased during the operation of a rechargeable lithium battery. By comparison, the sulfur-containing inorganic lithium compound according to an embodiment of the present disclosure may be free from the aforementioned problems. For example, the coating layer 5 may be substantially uniformly present on the surface of the lithium-containing composite oxide 3 and may thus prevent or reduce transition metal elution from the positive active material at a high temperature and suppress gas generation by reducing or suppressing side reactions at a high voltage.

In addition, the sulfur-containing inorganic lithium compound included in the coating layer 5 may not react with an electrolyte solution within the operating voltage range of the battery. Accordingly, the stability and cycle-life characteristics of a battery may be improved by suppressing surface structural changes of the positive active material 1.

When the surface of the positive active material 1 is analyzed using X-ray photoelectron spectroscopy (XPS), the sulfur-containing inorganic lithium compound may have a binding energy peak of about 168 eV to about 172 eV.

The sulfur-containing inorganic lithium compound may include lithium sulfate (Li₂SO₄), for example, Li₂SO₄, Li₂S₂O₄, or a combination thereof.

In general, a binding energy peak of photoelectrons emitted from a 2P_{3/2} orbital level of a sulfur (S) atom (e.g., an elemental sulfur atom) appears in a range of about 168.5 eV to about 169.6 eV when measured by XPS. By comparison, a binding energy peak of a sulfur (S) atom included in the coating layer of the present disclosure appears in a range of about 168 eV to about 172 eV, which is a little higher than the above binding energy peak.

The reason is that the sulfur-containing inorganic lithium compound includes a highly electronegative oxygen (O) atom around (e.g., near or bonded to) the sulfur (S) atom. For example, the elements in lithium sulfate (Li₂SO₄) have electronegativities of Li: 0.98, S: 2.58, and 0: 3.44, respectively, but the oxygen (O) atom is directly bonded with the sulfur (S) atom within the molecular structure of the lithium sulfate (Li₂SO₄) represented by Structural Formula 1. When a neighboring (e.g., a bonded) atom has higher electronegativity, a screening effect of the valence electrons on the analyzed atom tends to be decreased, the bonding energy of the core electrons tends to be increased, and accordingly, the high electronegativity of the oxygen (O) atom bonded with the sulfur (S) atom in the lithium sulfate (Li₂SO₄) may have a larger influence on the XPS peak of the analyzed sulfur (S) atom than lithium (Li) ions. Accordingly, in the positive active material according to an embodiment of the present disclosure, a binding energy peak of sulfur (S) as measured by XPS is observed at a higher range compared to a typically exhibited (e.g., elemental) sulfur (S) atom.

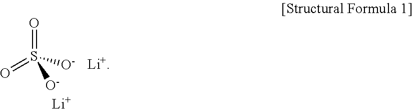

X-ray photoelectron spectroscopy can be used as a qualitative analysis method for the elements included in a sample (e.g., the material) by measuring the binding energy of photoelectrons, which is an inherent property of atoms. For example, when X-ray photons having a set or predetermined energy are applied to a sample, photoelectrons are emitted from the sample, and the kinetic energy of the photoelectrons may be measured in order to calculate the binding energy required to emit photoelectrons from the sample. The binding energy may be modulated depending on the chemical environment of the atom, for example due to a change in electronegativity. The chemical environment may be changed depending on the molecular structure containing the atom, a lattice position, and/or the like.

The lithium included in the sulfur-containing inorganic lithium compound may be derived from the lithium-containing composite oxide 3. Accordingly, the cycle-life characteristics and stability of a battery may be improved by reducing or decreasing the residual lithium on the surface of the positive active material 1, subsequently reducing or decreasing gas generation.

The sulfur-containing inorganic lithium compound may be included in about 1 wt % to about 25 wt %, about 1 wt % to about 20 wt %, about 1 wt % to about 15 wt %, about 1 wt % to about 10 wt %, or about 1 wt % to about 5 wt % based on a total weight of the positive active material. When the sulfur-containing inorganic lithium compound is included in the above-described ranges, an amount of residual lithium and gas present on a surface of the positive active material may be reduced, and thus cycle-life characteristics and stability of a battery may be improved.

A nickel content of the lithium-containing composite oxide 3 may be greater than or equal to about 55 at % (atom ic %), for example, greater than or equal to about 60 at %, greater than or equal to about 65 at %, greater than or equal to about 70 at %, greater than or equal to about 75 at %, or greater than or equal to about 80 at % based on a total amount of metals except lithium. In this case, high-capacity batteries capable of preventing or reducing cycle-life deterioration caused by residual lithium may be provided due to the coating layer including the sulfur-containing inorganic lithium compound.

The lithium-containing composite oxide 3 may be a lithium nickel-based composite oxide represented by Chemical Formula 1:

Liₐ(NiₓM_{y}′M_{z}″)O₂. Chemical Formula 1

In Chemical Formula 1, M′ may be at least one element selected from cobalt (Co), manganese (Mn), nickel (Ni), aluminum (Al), magnesium (Mg), and titanium (Ti), M″ may be at least one element selected from calcium (Ca), Mg, aluminum (Al), Ti, strontium (Sr), iron (Fe), Co, Mn, Ni, copper (Cu), zinc (Zn), yttrium (Y), zirconium (Zr), niobium (Nb), and boron (B), 0.8<a ≤1.2, 0.6≤x≤1, 0≤y≤0.4, 0≤z≤0.4, and 0.6≤x+y+z≤1.2.

For example, the lithium-containing composite oxide 3 may be a lithium nickel-based composite oxide represented by Chemical Formula 2:

Liₐ(NiₓCo_{y}Mn_{z})O₂. Chemical Formula 2

In Chemical Formula 2, 0.8<a≤1.2, 0.6≤x≤1, 0≤y≤0.4, 0≤z≤0.4 and 0.6≤x+y+z≤1.2.

The positive active material 1 may have a specific surface area (BET) of about 0.1 m²/g to about 10 m²/g, for example, about 0.45 m²/g to about 1.59 m²/g, or about 0.48 m²/g to about 1.50 m²/g. When the specific surface area of the positive active material 1 is within the above-described ranges, the electrochemical characteristics of the battery may be improved.

One or more example embodiments of the present disclosure provide a method of preparing a positive active material for a rechargeable lithium battery which includes injecting (e.g., mixing) a metal hydroxide precursor and a lithium source and firing the same at about 700° C. to about 800° C., wherein a sulfur-containing gas is injected (e.g., added) during the firing while decreasing the temperature.

The metal hydroxide precursor may have a composition represented by Chemical Formula 3:

NiₓM_{y}′M_{z}″(OH)₂. Chemical Formula 3

In Chemical Formula 3, M′ is at least one element selected from Co, Mn, Ni, Al, Mg, and Ti, M″ is at least one element selected from Ca, Mg, Al, Ti, Sr, Fe, Co, Mn, Ni, Cu, Zn, Y, Zr, Nb, and B, 0.6≤x1, 0≤y≤0.4, 0≤z≤0.4, and 0.6≤x+y+z≤1.2.

For example, the metal hydroxide precursor may have a composition represented by Chemical Formula 4:

NiₓCo_{y}Mn_{z}(OH)₂. Chemical Formula 4

In Chemical Formula 4, 0.6<x≤1, 0≤y≤0.4, 0≤z≤0.4 and 0.6≤x+y+z≤1.2.

The lithium source may be at least one of LiOH, Li₂CO₃, and a hydrate thereof.

The firing process may be to increase a temperature from room temperature (25° C.) up to 700° C. to 800° C. and to maintain the temperature for 6 to 20 hours.

Furthermore, the sulfur-containing gas may be injected (e.g., into a reactor) at about 400° C. to about 600° C., for example, at about 450° C. to about 550° C., or at about 500° C. When the injection temperature of the sulfur-containing gas is within the above-described range, side reactions in which unreacted residual lithium react with CO₂, H₂O, and/or the like in the air to generate gas may be reduced, and gelation of a composition (slurry) for a positive active material layer during the manufacture of a positive electrode may be suppressed or reduced. In addition, the sulfur-containing inorganic lithium compound may be uniformly formed on the surface of the layer and may thus improve the structural stability of the positive active material.

The sulfur-containing gas may be injected for greater than or equal to about 10 seconds, for example, greater than or equal to about 30 seconds, greater than or equal to about 60 seconds, or greater than or equal to about 120 seconds; and less than or equal to about 300 seconds, for example, less than or equal to about 240 seconds, less than or equal to about 180 seconds, or less than or equal to about 150 seconds.

In some embodiments, the sulfur-containing gas may be injected at a rate of about 0.1 to about 2 L/min, for example, about 0.3 to about 1 L/min, about 0.5 to about 1 L/min, or about 0.7 L/min to about 1 L/min.

Furthermore, the sulfur-containing gas may include sulfur dioxide (SO₂) gas in an amount of greater than or equal to about 5 volume %, for example, greater than or equal to about 10 volume %, greater than or equal to about 15 volume %, or greater than or equal to about 20 volume %; and less than or equal to about 100 volume %, for example, less than or equal to about 90 volume %, less than or equal to about 80 volume %, or less than or equal to about 70 volume % based on a total amount of the sulfur-containing gas including oxygen (O₂). For example, the remaining volume of the sulfur-containing gas may be or include O₂ or air.

A thickness of the coating layer may be adjusted or selected by controlling an injection temperature and/or injection time of the sulfur-containing gas and a sulfur dioxide content of the sulfur-containing gas.

The lithium source (e.g., a second lithium source) may be further injected concurrently or simultaneously with the injecting the sulfur-containing gas. The second lithium source may be the same as the above (first) lithium source.

When the metal hydroxide precursor has a low nickel content, the amount of residual lithium generated may be low, and accordingly, an additional lithium source may be further added (mixed) during the process of injecting the sulfur-containing gas. In some embodiments, the lithium source may be the same as that mixed during the firing process.

One or more example embodiments of the present disclosure provide a rechargeable lithium battery 100 including a positive electrode including the positive active material; a negative electrode; a separator disposed between the positive electrode and the negative electrode; and an electrolyte solution between the positive electrode and the negative electrode.

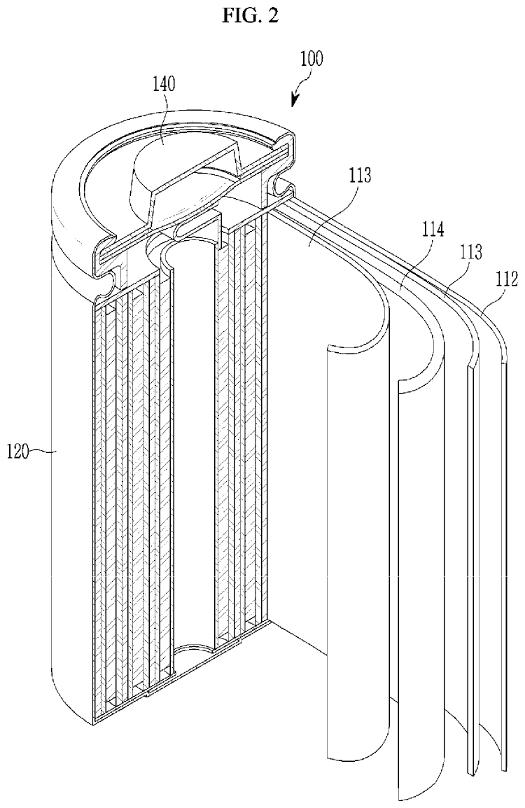

FIG. 2 is a schematic perspective view showing a representative structure of a rechargeable lithium battery. Referring to FIG. 2, a rechargeable lithium battery 100 includes a positive electrode 112 including the positive active material according to an embodiment of the present disclosure, a negative electrode 114, and a separator 113. The positive electrode 112, the negative electrode 114, and the separator 113 are wound or folded to be housed in a battery case 120. Then, an organic electrolyte solution is injected and sealed in the battery case 120 with a cap assembly 140 to complete a rechargeable lithium battery 100.

The battery case 120 may be cylindrical, prismatic, thin film-type (format), and/or the like. The rechargeable lithium battery may be a lithium ion battery.

The rechargeable lithium battery may have excellent storage stability, cycle-life characteristics, and/or high-rate characteristics at high temperatures, and may be suitable for use in an electric vehicle (EV). For example, it may be used for a hybrid vehicle such as a plug-in hybrid electric vehicle (PHEV).

The positive electrode 112 may be manufactured by applying a composition for a positive active material layer on a current collector and drying the same.

The composition for forming the positive active material layer may be prepared by mixing a positive active material, a conductive agent, a binder, and a solvent, and the positive active material is as described above.

The binder is a component that assists in binding of the active material to the conductive agent and to the current collector. The binder may be added in an amount of about 0.5 to about 50 parts by weight based on a total weight of 100 parts by weight of the positive active material. Non-limiting examples of the binder include polyvinylidene fluoride, polyvinyl alcohol, carboxylmethyl cellulose (CMC), starch, hydroxypropyl cellulose, regenerated cellulose, polyvinylpyrrolidone, tetrafluoroethylene, polyethylene, polypropylene, an ethylene-propylene-diene terpolymer (EPDM), sulfonated EPDM, a styrene butadiene rubber, a fluoro rubber, and various copolymers. An amount of the binder may be about 2 to about 5 parts by weight based on a total weight of 100 parts by weight of the positive active material. When the amount of the binder is in the above range, a binding force of the active material layer to the current collector may be improved.

The conductive agent is not particularly limited as long as it has electronic conductivity without causing unwanted chemical changes in a battery, and may be or include, for example, graphite (such as natural graphite and/or artificial graphite); a carbon-based material (such as carbon black, acetylene black, ketjen black, channel black, furnace black, lamp black, thermal black, and/or the like); a conductive fiber (such as a carbon fiber and/or a metal fiber); carbon fluoride; a metal powder (such as aluminum and/or nickel powder); a conductive whisker (such as zinc oxide and/or potassium titanate); a conductive metal oxide (such as titanium oxide); and/or a conductive material (such as a polyphenylene derivative). An amount of the conductive agent may be about 2 to about 5 parts by weight based on a total weight of 100 parts by weight of the positive active material. When the amount of the conductive agent is in the above-described ranges, the conductivity of the finally obtained electrode is improved.

Non-limiting examples of the solvent include N-methylpyrrolidone and the like. An amount of the solvent may be about 1 to about 10 parts by weight based on 100 parts by weight of the positive active material. When the amount of the solvent is within the above-described range, it may be easy to form the active material layer.

The positive current collector may be about 3 μm to about 500 μm thick, is not particularly limited if it has high conductivity without causing unwanted chemical changes in the battery, and may be, for example, stainless steel, aluminum, nickel, titanium, heat-treated carbon, or aluminum or stainless steel that is surface-treated with carbon, nickel, titanium, silver, and/or the like. The current collector may include a fine concavo-convex texture on its surface to enhance adherence of positive active materials, and may be in any suitable form (such as films, sheets, foils, nets, porous bodies, foams, and/or nonwoven fabric bodies).

The negative electrode 114 is manufactured by applying a composition for a negative active material layer on a current collector and drying the same.

The composition for the negative active material layer may be prepared by mixing a negative active material, a binder, a conductive agent, and a solvent.

The negative active material is a material capable of intercalating and releasing lithium ions. Non-limiting examples of the negative active material include a carbon-based material (such as graphite and/or carbon), a lithium metal, an alloy thereof, and a silicon oxide-based material. In some embodiments, silicon oxide may be used.

The binder, the conductive agent, and the solvent may be the same types or kinds of materials as used in the positive electrode. The binder may be added in an amount of about 1 to about 50 parts by weight based on a total weight of 100 parts by weight of the negative active material. The conductive agent may be added in an amount of about 1 to about 5 parts based on a total weight of 100 parts by weight of the negative active material. When the amount of the conductive agent is in the above-described range, the conductivity characteristics of the finally obtained electrode may be improved. An amount of the solvent may be about 1 to about 10 parts by weight based on 100 parts by weight of the negative active material. When the amount of the solvent is within the above-described range, it may be easy to form the negative active material layer.

The negative current collector may be about 3 μm to about 500 μm thick. The negative current collector is not particularly limited as long as it has high conductivity without causing unwanted chemical changes in the battery, and may be, for example, copper, stainless steel, aluminum, nickel, titanium, heat-treated carbon, copper or stainless steel that is surface-treated with carbon, nickel, titanium, silver, and/or the like, an aluminum-cadmium alloy, and/or the like. In some embodiments, the negative current collector may include a fine concavo-convex texture on its surface to enhance adherence of negative active materials and may be in any suitable form (such as films, sheets, foils, nets, porous bodies, foams and/or nonwoven fabric bodies), similar to the positive current collector.

The separator 113 is disposed between the positive electrode and the negative electrode according to the method described herein. The separator may have a pore diameter of about 0.01 μm to about 10 μm and a thickness of about 5 μm to about 300 μm. Non-limiting examples of the material for forming the separator include polypropylene, polyethylene and other olefin based polymers; and sheets made of a glass fiber and/or a non-woven fabric. When a solid electrolyte such as a polymer is used as the electrolyte, a solid electrolyte may also serve as a separator.

The electrolyte may be a non-aqueous electrolyte including a non-aqueous solvent and a lithium salt, an organic solid electrolyte, an inorganic solid electrolyte, and/or the like. The non-aqueous solvent may be, for example, an aprotic organic solvent (such as N-methyl-2-pyrrolidinone, propylene carbonate, ethylene carbonate, butylene carbonate, dimethyl carbonate, diethyl carbonate, gamma-butyro lactone, 1,2-dimethoxyethane, 2-methyl tetrahydrofuran, dimethylsulfoxide, 1,3-dioxolane, formamide, N,N-dimethyl formamide, dioxolane, acetonitrile, nitromethane, methyl formate, methyl acetate, phosphoric acid triester, trimethoxy methane, a dioxolane derivative, sulfolane, methyl sulfolane, 1,3-dimethyl-2-imidazolidinone, a propylene carbonate derivative, a tetrahydrofuran derivative, ether, methyl propionate, ethyl propionate, and/or the like). The lithium salt is dissolved in the non-aqueous electrolyte, and non-limiting examples thereof include LiCl, LiBr, Lil, LiCO4, LiBF₄, LiB₁₀Cl₁₀, LiCF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lower aliphatic lithium carboxylate, tetraphenyl lithium borate, imide, and/or the like.

The organic solid electrolyte may be a polyethylene derivative, a polyethylene oxide derivative, a polypropylene oxide derivative, a phosphoric acid ester polymer, polyester sulfide, polyvinyl alcohol, polyvinylidene fluoride, and/or the like.

The inorganic solid electrolyte may be Li₃N, Lil, Li₅NI₂, Li₃N-Lil-LiOH, LiSiO₄, LiSiO₄-Lil-LiOH, Li₂SiS₃, Li₄SiO₄, Li₃PO₄-Li₂S-SiS₂, and/or the like.

The present disclosure is explained in more detail in the following examples and comparative examples. It is to be understood, however, that the examples are for the purpose of illustration and are not to be construed as limiting the present disclosure.

### EXAMPLE 1

### (Preparation of Positive Active Material)

A lithium source, (LiOH·H₂O), and a metal hydroxide precursor, (Ni_{0.91}Co_{0.06}Mn_{0.03})(OH)₂, were mixed in a mole ratio of 1.1:1.0, and then fired under an O₂ atmosphere at 700° C. for 10 hours.

Subsequently, while cooled down, a sulfur-containing gas including 100 volume % of sulfur dioxide gas (SO₂) was injected into the reactor or reaction mixture at 500° C. for 60 seconds at 1 L/min, and the temperature was decreased to room temperature to yield a positive active material.

### (Manufacture of Coin Cell)

The positive active material, a carbon black carbon conductive agent (Denka Black, Denka Korea Co., Ltd.), and polyvinylidene fluoride (PVdF) were mixed in a weight ratio of 92:4:4, and then mixed with N-methylpyrrolidone (NMP) to prepare slurry. The slurry was bar-coated on a 15 μm-thick aluminum current collector, vacuum-dried at room temperature (24° C.) and once more at 120° C., compressed, and punched to manufacture a 45 μm-thick positive electrode plate.

The positive electrode plate was used along with a lithium metal as a counter electrode, a PTFE separator, and an electrolyte prepared by dissolving 1.3 M LiPF₆ in a mixed solvent of EC (ethylene carbonate), DEC (diethyl carbonate), and EMC (ethylmethyl carbonate) in a volume ratio of 3:4:3 to manufacture a coin cell.

### EXAMPLE 2

A positive active material and a coin cell using the same were manufactured according to substantially the same method as Example 1, except that sulfur-containing gas including 5 volume % of sulfur dioxide gas (SO₂) and 95 volume % of oxygen was used.

### EXAMPLE 3

A positive active material and a coin cell using the same were manufactured according to substantially the same method as Example 1, except that sulfur-containing gas including 5 volume % of sulfur dioxide gas (SO₂) and 95 volume % of oxygen was used, and the sulfur-containing gas was injected at 0.7 L/min.

### EXAMPLE 4

A positive active material and a coin cell using the same were manufactured according to substantially the same method as Example 1, except that the sulfur-containing gas including 5 volume % of sulfur dioxide gas (SO₂) and 95 volume % of oxygen was injected at 0.5 L/min.

### EXAMPLE 5

A positive active material and a coin cell using the same were manufactured according to substantially the same method as Example 1, except that the sulfur-containing gas including 5 volume % of sulfur dioxide gas (SO₂) and 95 volume % of oxygen was injected at 0.3 L/min.

### EXAMPLE 6

A positive active material and a coin cell using the same were manufactured according to substantially the same method as Example 1, except that the sulfur-containing gas was injected at 2.0 L/min.

### Comparative Example 1

A positive active material and a coin cell using the same were manufactured according to substantially the same method as Example 1, except that the sulfur-containing gas was not injected (included).

### Comparative Example 2

100 parts by weight of LiNi_{0.88}Co_{0.10}Mn_{0.02}O₂ powder having an average particle diameter of 11.25 μm (based on PSD D50) (Ecopro Co., Ltd.) was washed with distilled water to remove impurities and residual lithium. The washed LiNi_{0.88}Co_{0.10}Mn_{0.02}O₂ powder was dried at 120° C. for 4 hours. The dried LiNi_{0.88}Co_{0.10}Mn_{0.02}O₂ powder was dispersed in 95 parts by weight of distilled water. 1 part by weight of lithium dodecyl sulfate (LDS, Sigma Aldrich Co., Ltd.) was added to 5 parts by weight of distilled water and dissolved therein to prepare a coating liquid. The coating liquid was added to the distilled water in which LiNi_{0.88}Co_{0.10}Mn_{0.02}O₂ powder was dispersed, and the mixture was stirred with an agitator (Jeio Tech Co., Ltd.) for 120 minutes to coat the lithium dodecyl sulfate (LDS) on the surface of the washed LiNi_{0.88}Co_{0.10}Mn_{0.02}O₂ powder. The LiNi_{0.88}Co_{0.10}Mn_{0.02}O₂ powder coated with the lithium dodecyl sulfate (LDS) was dried at 100° C. for 12 hours to remove the distilled water remaining there. Subsequently, the dried resulting material was fired at 600° C. to 700° C. for 5 hours in the air to prepare a positive active material having a coating layer.

### Evaluation Example 1

### Evaluation of Thickness of Coating Layer

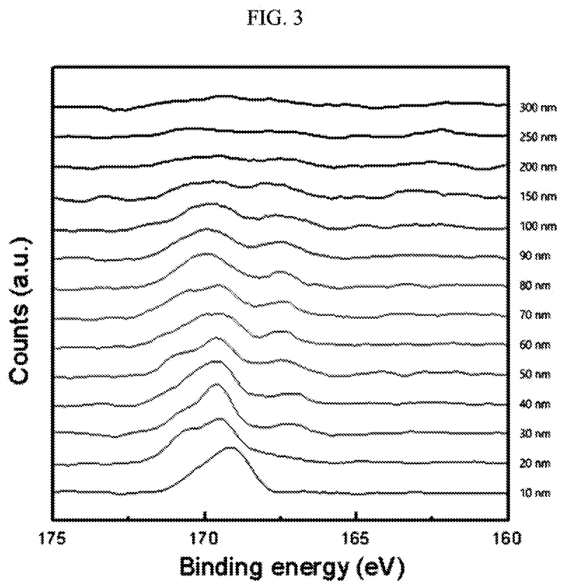

XPS depth profiling was used to perform an elemental analysis of sulfur (S) concentrations depending on the depth from the surface of a positive active material in the positive active materials according to Examples 1 to 6, by detecting the 2P orbital binding energy peak of sulfur (S). FIG. 3 is a graph showing the XPS depth profiling of the positive active material prepared in Example 1.

Referring to FIG. 3, a sulfur (S) atom included in the coating layer of the positive active material of Example 1 showed a binding energy peak in a range of 168 eV to 172 eV, which appeared within a depth of less than or equal to 100 nm, and accordingly, the coating layer of the positive active material according to Example 1 was found to have a thickness of less than or equal to 100 nm.

The coating layer thickness of each of the positive active materials according to Examples 2 to 6 was measured in the same method as in Example 1. The results of Examples 1 to 5 are shown in Table 1.

TABLE 1

| | | | Gas injection | | Thickness |
|---|---|---|---|---|---|
| | SO₂ content | Gas injection | temperature | Gas injection | of coating |
| | (volume %) | amount (L/min) | (° C.) | time (s) | layer (nm) |
| Example 1 | 100 | 1 | 500° C. | 60 seconds | 100 |
| Example 2 | 5 | 1 | | | 20 |
| Example 3 | 5 | 0.7 | | | 15 |
| Example 4 | 5 | 0.5 | | | 10 |
| Example 5 | 5 | 0.3 | | | 1 |

Referring to Table 1, the thicknesses of the coating layers of the positive active materials according to Example 1 to 5 were in a range of 1 to 100 nm.

### Evaluation Example 2

### Evaluation of Unreacted Residual Lithium Content

The residual lithium contents of positive active materials prepared in Examples 1 to 5 and Comparative Example 1 were measured, and the results are shown in Table 2. The residual lithium contents were measured using a titration method. For example, the positive active material powders were dissolved in water and titrated with hydrochloric acid to calculate the contents of LiOH and Li₂CO₃ included on the surface of the positive active materials. The resulting Li contents as calculated are shown in Table 2.

TABLE 2

| | Residual lithium |
|---|---|
| | content (ppm) |
| | (Li content in |
| | Li₂CO₃ & LiOH) |
| Comparative | 4910 |
| Example 1 | |
| Example 1 | 1743 |
| Example 2 | 3563 |
| Example 3 | 3817 |
| Example 4 | 3418 |
| Example 5 | 4134 |

Referring to Table 2, residual lithium contents of the positive active materials according to Examples 1 to 5 were reduced (e.g., decreased) compared with the positive active material according to Comparative Example 1, which did not include a sulfur-containing inorganic lithium compound.

For example, the positive active material according to Example 5 had a very thin coating layer thickness of 1 nm, but showed a residual lithium reduction effect. Without being bound by the correctness of any explanation or theory, it is thought that sulfur-containing SO₂ gas reacted with the residual lithium and thus was not only converted into lithium sulfate (Li₂SO₄), but also had an influence on a residual lithium-generating mechanism to further suppress generation of residual lithium and effectively reduce the residual lithium.

### Evaluation Example 3

### Elemental Analysis of Coating Layer by XPS

Regarding the positive active materials according to Example 1 and Comparative Example 2, the 2P orbital binding energy of sulfur (S) of the sulfur-containing inorganic lithium compound was measured by X-ray photoelectron spectroscopy (XPS), and the results are shown in Table 3.

TABLE 3

| | Binding energy | Components of |
|---|---|---|
| | of S (eV) | coating layer |
| Example 1 | 168 to 172 eV | Li₂SO₄, Li₂S₂O₄ |
| | | (small amount) |
| Comparative | 166.9 eV | LDS |
| Example 2 | | |

Referring to Table 3, the positive active material of Example 1 showed an XPS measurement in a range of 168 to 172 eV, which is higher than 166.9 eV of 2P orbital binding energy of a sulfur (S) element included in the LDS (lithium dodecyl sulfate) coating of Comparative Example 2. The XPS measurement of Example 1 corresponds to 168 to 172 eV of a 2P orbital binding energy range of sulfur (S) in lithium sulfate (Li₂SO₄) which was measured by XPS (Source: J. Electron Spectrosc. 2007, 156-158, 310-314, FIG. 1 S 2p and O 1s spectra of Group 1A sulfates.). Accordingly, the sulfur-containing lithium inorganic compound included in Example 1 was confirmed to include lithium sulfate (Li₂SO₄).

In addition, the sulfur-containing inorganic lithium compound also included a small amount of Li₂S₂O₄ showing a binding energy peak in a range of 166 to 167 eV.

### Evaluation Example 4

### EDS (Energy Dispersive Spectroscopy) Analysis

As for the positive active materials according to Examples 1 to 5 and Comparative Example 1, EDS was used to analyze amounts of metal elements except for Li, and the results are shown in Table 4.

TABLE 4

| | Nickel | Cobalt | Manganese | Sulfur | |
|---|---|---|---|---|---|
| | (at %) | (at %) | (at %) | (at %) | Ni:Co:Mn |
| Comparative | 89.01 | 5.77 | 3.55 | 1.67 | 90.5:5.9:3.6 |
| Example 1 | | | | | |
| Example 1 | 78.07 | 4.74 | 2.84 | 14.35 | 91.2:5.5:3.3 |
| Example 2 | 87.88 | 5.19 | 2.87 | 4.06 | 91.6:5.4:3.0 |
| Example 3 | 88.21 | 5.46 | 3.44 | 2.88 | 90.8:5.6:3.5 |
| Example 4 | 88.32 | 5.72 | 3.35 | 2.60 | 90.7:5.9:3.4 |
| Example 5 | 88.87 | 6.03 | 3.02 | 2.08 | 90.8:6.2:3.1 |

Referring to the sulfur (at %) of Table 4, a significant amount (greater than 2 at %) of sulfur was found on the surfaces of the positive active materials according to Examples 1 to 5, but in the positive active material according to Comparative Example 1, sulfur was found at an impurity level (e.g., less than or equal to 2 at %). For example, in the context of repetitive measurements and principles of quantitative analysis, as for Comparative Example 1, the detected X-ray spectrum appeared to only include a noise peak, and resultantly, the sulfur element was not substantially present on the surface of the positive active material according to Comparative Example 1.

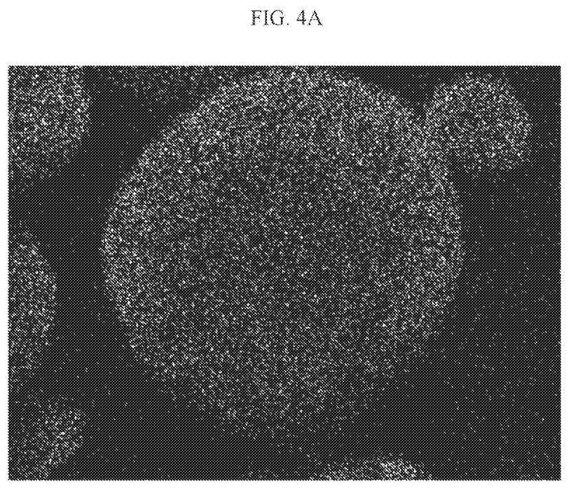

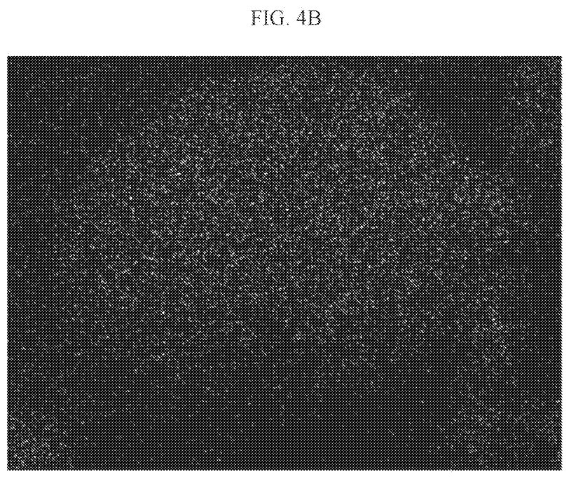

In addition, energy dispersive spectroscopy (EDS) analyses of sulfur present on the surfaces of the positive active materials according to Example 1 and Comparative Example 1 are shown in FIGS. 4A and 4B, respectively. FIG. 4A shows the results of EDS analysis for sulfur (S) on the surface of the positive active material prepared in Example 1, and FIG. 4B shows the results of EDS analysis for sulfur (S) on the surface of the positive active material prepared in Comparative Example 1. Referring to FIGS. 4A and 4B, a relatively large amount (concentration) of sulfur-containing lithium inorganic compound was uniformly present on the surface of the positive active material according to Example 1, while a relatively low amount of sulfur, for example, within an impurity or noise level was present in the positive active material according to Comparative Example 1.

### Evaluation Example 5

### XRD (X-Ray Diffraction) Analysis

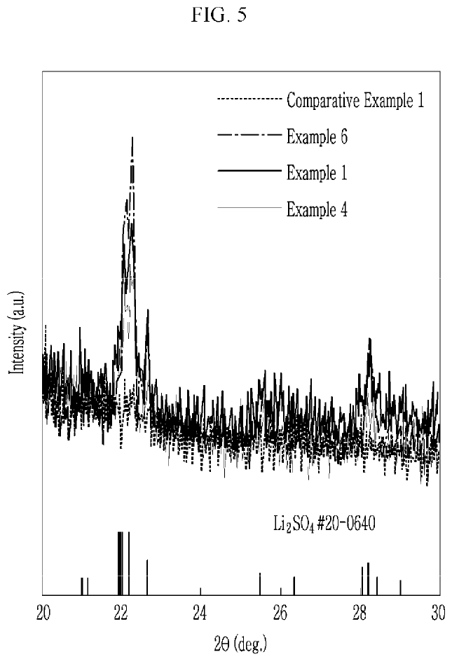

An X-Ray Diffraction (XRD) analysis of the positive active materials of Examples 1, 4, and 6 and Comparative Example 1 was performed, and the results are shown in FIG. 5. The X-ray diffraction analysis was performed using D2 PHASER (BRUKER Company), and a CuKα ray was used as a light source within a range of 10°≤2θ≤90° at a scan rate of 1°/min.

The bar graph at the bottom of FIG. 5 corresponds to a lithium sulfate (Li₂SO₄) spectrum, as retrieved from International Centre for Diffraction Data (ICDD) card number Li₂SO₄#20-0640.

Referring to FIG. 5, Examples 1 and 4 and Reference Example 1 showed a peak (intensity) at 2θ(deg.)=22° to 23° as shown in the bar graph, which showed that lithium sulfate (Li₂SO₄) was present on the surface of the positive active material, but Comparative Example 1 did not.

### Evaluation Example 6

### Evaluation of Gas Generation Amount at High Temperature

The coin cells according to Examples 1 to 5 and Comparative Example 1 were 0.1 C charged to a voltage of 4.3 V (vs. Li) under a constant current condition at 25° C. and subsequently, 0.05 C cut off under a constant voltage mode, while the 4.3 V was maintained. Subsequently, the coin cells were dissembled, and the positive electrodes were removed and placed in respective pouches containing an electrolyte solution (a solution including 1.5 M LiP F₆ dissolved in a mixed solvent of EC (ethylene carbonate), DEC (diethyl carbonate), and EMC (ethylmethyl carbonate) in a volume ratio of 2:4:4). Each pouch was sealed and stored at 80° C. for 4 weeks to measure a volume change. Herein, an Archimedes method was used to measure the volume change of the pouch over time, and the results are shown in Table 5.

As used herein, the term “Archimedes method” refers to a method of repeatedly measuring a weight of the pouch in a tank filled with water (e.g., every 4 days) and converting the weight change into a volume change to measure a gas generation amount.

TABLE 5

| | Gas generation |
|---|---|
| | amount (cc/g) |
| Comparative | 4709 |
| Example 1 | |
| Example 1 | 3477 |
| Example 2 | 3144 |
| Example 3 | 3288 |
| Example 4 | 3677 |
| Example 5 | 3478 |

Referring to Table 5, the coin cells according to Examples 1 to 5 showed a reduced gas generation amount compared with the coin cell according to Comparative Example 1.

### Evaluation Example 7

### Evaluation of Cycle-life Characteristics at High Temperature

The coin cells according to Examples 4 and 5 and Comparative Example 1 were charged under constant current at a current of 0.1 C to a voltage of 4.3 V (vs. Li) at 25° C. and subsequently, charged under constant voltage at a cut-off current of 0.05 C while the 4.3 V was maintained. Subsequently, the coin cells were discharged to a voltage of 3 V (vs. Li) under a constant current at a 0.1 C rate (1st cycle). After the 1st cycle, the coin cells were charged at 1.0 C charged under a constant current at 45° C. to a voltage of 4.3 V (vs. Li) and then, charged under constant voltage at a cut-off current of 0.05 C while the 4.3 V was maintained. Subsequently, the coin cells were discharged at 1.0 C under constant current to a voltage of 3.0 V (vs. Li), and the cycle was repeated up to a 50^{th} cycle. A pause (rest) of 10 minutes was set after every charge/discharge cycle. As the charge and discharge experiment result, a capacity retention at the 50^{th} cycle was calculated according to Equation 1 and shown in Table 6.

### [Equation 1]

Capacity retention [%] at 50^{th} cycle=[Discharge capacity at 50^{th} cycle/Discharge capacity at 1^{st} cycle]×100

TABLE 6

| | Capacity retention |
|---|---|
| | (50^{th} cycle, %) |
| Example 4 | 88.3 |
| Example 5 | 87.1 |
| Comparative | 81.0 |
| Example 1 | |

Referring to Table 6, the coin cells according to Examples 4 and 5 showed improved capacity retention by effectively removing residual lithium on the surface of the positive active material compared with the coin cell according to Comparative Example 1.

As used herein, the terms “use”, “using”, and “used” may be considered synonymous with the terms “utilize”, “utilizing”, and “utilized”, respectively. Further, the use of “may” when describing embodiments of the present disclosure refers to “one or more embodiments of the present disclosure”.

As used herein, the terms “substantially”, “about”, and similar terms are used as terms of approximation and not as terms of degree, and are intended to account for the inherent deviations in measured or calculated values that would be recognized by those of ordinary skill in the art.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims and equivalents thereof.

### Description of Some of the Symbols

| | |
|---|---|
| 1: | positive active material |
| 3: | lithium-containing composite oxide |
| 5: | coating layer |
| 100: | rechargeable lithium battery |
| 114: | negative electrode |
| 112: | positive electrode |
| 113: | separator |
| 120: | battery case |
| 140: | cap assembly |

What is claimed is:

1. A positive active material for a rechargeable lithium battery, comprising:
a lithium-containing composite oxide; and
a sulfur-containing inorganic lithium compound,
wherein the sulfur-containing inorganic lithium compound forms a coating layer on a surface of the lithium-containing composite oxide.

2. The positive active material of claim 1, wherein an X-ray photoelectron spectroscopy (XPS) binding energy peak of the sulfur-containing inorganic lithium compound is exhibited at about 168 eV to about 172 eV.

3. The positive active material of claim 1, wherein the sulfur-containing inorganic lithium compound comprises lithium sulfate.

4. The positive active material of claim 1, wherein the lithium of the sulfur-containing inorganic lithium compound is derived from the lithium-containing composite oxide.

5. The positive active material of claim 1, wherein the coating layer has a thickness of about 1 nm to about 100 nm.

6. The positive active material of claim 1, wherein the sulfur-containing inorganic lithium compound is included in an amount of about 1 wt % to about 20 wt % based on a total weight of the positive active material.

7. The positive active material of claim 1, wherein the coating layer is formed as a uniform film on the surface of the lithium-containing composite oxide.

8. The positive active material of claim 1, wherein a nickel content of the lithium-containing composite oxide is greater than or equal to about 55 at % based on a total amount of metals except lithium.

9. The positive active material of claim 1, wherein a nickel content of the lithium-containing composite oxide is greater than or equal to about 80 at % based on a total amount of metals except lithium.

10. The positive active material of claim 1, wherein the lithium-containing composite oxide comprises a lithium nickel composite oxide represented by Chemical Formula 1:
Liₐ(NiₓM_{y}′M_{z}″)O₂, <Chemical Formula 1>
wherein, in Chemical Formula 1, M′ is at least one element selected from Co, Mn, Ni, Al, Mg, and Ti, M″ is at least one element selected from Ca, Mg, Al, Ti, Sr, Fe, Co, Mn, Ni, Cu, Zn, Y, Zr, Nb, and B, 0.8 <a≤1.2, 0.6≤x≤1, 0≤y ≤0.4, 0≤z≤0.4, and 0.6≤x+y+z≤1.2.

11. The positive active material of claim 1, wherein the lithium-containing composite oxide comprises a lithium nickel composite oxide represented by Chemical Formula 2:
Liₐ(NiₓCo_{y}Mn_{z})O₂, <Chemical Formula 2>
wherein, in Chemical Formula 2, 0.8<a≤1.2, 0.6≤x≤1, 0≤y≤0.4, 0≤z≤0.4, and 0.6≤x+y+z≤1.2.

12. The positive active material of claim 1, wherein the positive active material has a specific surface area (BET) of about 0.01 m²/g to about 10 m²/g.

13. A method of preparing a positive active material for a rechargeable lithium battery, comprising:
injecting a metal hydroxide precursor and a lithium source to form a mixture; and
firing the mixture at a reaction temperature of about 700° C. to about 800° C.,
wherein a sulfur-containing gas is injected during the firing while decreasing the reaction temperature.

14. The method of claim 13, wherein an injection temperature of the sulfur-containing gas is about 400° C. to about 600° C.

15. The method of claim 13, wherein an injection time of the sulfur-containing gas is from about 10 seconds to about 300 seconds.

16. The method of claim 13, wherein an injection amount of sulfur-containing gas is about 0.1 L/min to about 2 L/min.

17. The method of claim 13, wherein the sulfur-containing gas comprises about 5 volume % to about 100 volume % of a sulfur dioxide (SO₂) gas.

18. The method of claim 13, wherein the lithium source is further injected during injecting the sulfur-containing gas.

19. A rechargeable lithium battery, comprising:
a positive electrode comprising the positive active material of claim 1;
a negative electrode;
a separator between the positive electrode and the negative electrode; and
an electrolyte solution between the positive electrode and the negative electrode.
